(19) United States
(12) Patent Application Publication
(10) Pub. No.: US 2010/0198766 A1
(43) Pub. Date: Aug. 5, 2010

(54) Nano-Electric Synapse and Method for Training Said Synapse

(75) Inventors: Jacques-Olivier Klein, Bures sur Yvette (FR); Eric Belhaire, Cachan (FR)

Correspondence Address: MILLER, MATTHIAS & HULL, ONE NORTH FRANKLIN STREET, SUITE 2350, CHICAGO, IL, 60606, US

(73) Assignee: Universite Paris Sud (Paris ll), Paris Cedex 16 (FR)

(21) Appl. No.: 12/670,992

(22) PCT Filed: Jul. 24, 2008
(86) PCT No.: PCT/FR2008/051389

§ 371 Date: Jan. 27, 2010

(30) Foreign Application Priority Data
Jul. 27, 2007 (FR) 0705532

(51) Int. Cl. G06E 1/00; G06F 15/18; G06E 3/00

(52) U.S. Cl. 706/25; 706/26; 706/15

(57) ABSTRACT

The invention relates to an electric synapse that comprises a main conductor with a predetermined potential V1, a secondary conductor said secondary conductor having a potential V_{X1+} that can vary between Vref−Vn and Vref+Vn, Vref being the reference potential, a nanoconductor with an adjustable conductance W₁, the main conductor being connected to said secondary conductor through an adjustable conductance nanoconductor, one end at least of the main conductor being connected to an electric neuron, said electric neuron being capable of realizing a threshold function and applying a training control potential Va of Vref−Vp or Vref+Vp to the main conductor when the voltage O₁ obtained at the output of said threshold function is different from the expected voltage T₁, wherein the Vn and Vp potentials comply with: 2*Vn<Vt and |Vp−Vn|<Vt<|Vp+Vn|.

This invention relates to an electric synapse, as well as to a set of synapses and a network of electric neurons comprising a plurality of such electric synapses. The invention also relates to a training method of such an electric synapse or of such a set of synapses and to such a network of neurons.

Currently, most integrated circuits are realized based on MOS (Metal Oxide Semiconductor) transistors. Increasing the integration density of digital circuits is a constant need.

The progressive introduction of nanotechnologies, in particular of self-assembled elements, makes it possible to pursue increasing the integration density of digital circuits without exploding their manufacturing cost.

In light of the properties of these components, their component-to-component characteristics within an integrated circuit are much less reproducible than with the MOS technologies.

Alternative architectures of elementary blocks must therefore be developed.

These alternative architectures must be tolerant to the dispersions of the characteristics of nanocomponents, tolerate a considerable rate of defects, while still remaining insensitive to the substantial noise that can be generated by the nanocomponents and have self-compensating capacities for these dispersions.

Constructing blocks according to architectures of electric neuron networks is a possible path. The training capacity of networks of neurons can be used in order to automatically offset the dispersion of the components but also in order to allow for the implementation of training methods for a function to be carried out.

The characteristic of the block and the function to be carried out are then stored in the mass of connections of the network of electric neurons called electric synapses.

A certain number of training methods are known, however there is no architecture for the components of the circuit making possible the simple realization of these training methods, which most often require in principle an access to each of the components.

The invention has in particular for purpose to propose such an architecture.

To that effect, the invention has for object an electric synapse comprising at least:

a. a main conductor at a predetermined potential V1,

b. a secondary conductor, said secondary conductor having a potential V_{X1+}, that can vary between Vref−Vn and Vref+Vn, Vref being the reference potential,

c. a nanoconductor with adjustable conductance W₁, the conductance W₁ remaining constant as long as the voltage on the terminals of said nanoconductor remains less in absolute value than a threshold voltage Vt,

the main conductor being connected to said secondary conductor by means of a nanoconductor with an adjustable conductance, one end at least of the main conductor being connected to an electric neuron, wherein said electric neuron being capable of realizing a threshold function and applying a training potential Va of Vref−Vp or Vref+Vp to the main conductor when the voltage O₁ obtained at the output of said threshold function differs from the expected voltage T₁, wherein the potentials Vn and Vp comply with: 2*Vn<Vt and |Vp−Vn|<Vt<|Vp+Vn|.

Such an architecture of the synapse according to the invention makes it possible to modify the conductance W₁ of said nanoconductor when its potential V_{X1+}, in reference to Vref is of the opposite sign of V1−Vref, in relation to Vref, and to not modify said conductance W₁ of said nanoconductor when its potential V_{X1+}, in reference to Vref, is of the same sign, in relation to Vref, as V1−Vref.

An electric synapse according to the invention can further comprise one or several of the optional features hereinbelow, considered individually or according to all of the possible combinations:
the variation in the conductance W₁ of the nanoconductor according to the voltage on these terminals is monotonic;
the nanoconductor is a multi-wall carbon nanotube;
when the nanoconductor is of decreasing conductance the electric neuron is conformed in such a way as to apply a training control potential Vref−Vp or Vref+Vp of the opposite sign, in relation to Vref, to the voltage O₁ obtained at the output of said threshold function;
when the nanoconductor is of increasing conductance the electric neuron is conformed in such a way as to apply a training control potential Vref−Vp or Vref+Vp of the same sign, in relation to Vref, as the voltage O₁ obtained at the output of said threshold function.

The invention also relates to a set of electric synapses comprising at least:

a. a synapse according to the invention,

b. a second secondary conductor, said second secondary conductor with a potential Vₓ₁₋, that can vary between Vref−Vn and Vref+Vn, in such a way that the average potential between V_{X1+} and V_{X1-}, is equal to Vref, Vref being the reference potential,

c. a second nanoconductor with adjustable conductance W₂, said conductance W₂, remaining constant as long as the voltage on the terminals of said nanoconductor remains less in absolute value than a threshold voltage Vt,

the main conductor being linked independently to each secondary conductor by means of a nanoconductor with an adjustable conductance, one end at least of the main conductor being connected to an electric neuron, wherein said electric neuron is capable of realizing a threshold function and applying a training control potential Vp to the main conductor when the voltage O₁ obtained at the output of said threshold function differs from the expected voltage T₁, and wherein the potentials Vn and Vp comply with: 2*Vn<Vt and |Vp−Vn|<Vt<|Vp+Vn|.

Such an architecture of the set of synapses according to the invention makes it possible to modify the conductance W₁, W₂, of any nanoconductor of which the potential V_{X1+}, V_{X1-}, in reference to Vref, is of the opposite sign of V1−Vref and to not modify said conductance W₁, W₂, of any nanoconductor of which the potential V_{X1+}, V_{X1-}, in reference to Vref, is of the same sign as V1−Vref, in the absence of direct access to each nanoconductor.

A set of synapses according to the invention can further comprise one or several of the optional features hereinbelow, considered individually or according to all of the possible combinations:
the variation in the conductance W₁, W₂, of each nanoconductor according to the voltage on the terminals is monotonic;
the variations in the conductances according to the voltage of any nanoconductor subset have the same monotony;
the nanoconductors are multi-wall carbon nanotubes;
when the nanoconductors are of decreasing conductance the electric neuron is conformed in such a way as to apply a training control potential Vref−Vp or Vref+Vp of the opposite sign, in relation to Vref, to the voltage O₁ obtained at the output of said threshold function;
when the nanoconductor is of increasing conductance the electric neuron is conformed in such a way as to apply a training control potential Vref−Vp or Vref+Vp of the same sign, in relation to Vref, as the voltage O₁ obtained at the output of said threshold function.

The invention also relates to a training method of a synapse or of a set of synapses according to the invention, wherein when the voltage O₁ obtained at the output of the threshold function differs from the expected voltage T₁, wherein the training control potential Vref−Vp or Vref+Vp, Vp complying with |Vp−Vn|<Vt<|Vp+Vn|, is applied to the main conductor.

The invention also has for object a network of neurons comprising a plurality of synapses or of sets of synapses according to the invention, wherein for each synapse or set of synapses of said network each of its secondary conductors is electrically connected to at least one main conductor of another synapse or set of synapses of the network.

The invention also relates to a training method of a network of neurons, wherein the training method according to the invention of a synapse or of a set of synapses is applied globally to each synapse or set of synapses of said network by means of a single training control potential Vref−Vp or Vref+Vp per main conductor.

The invention shall be better understood when reading the following description, provided solely by way of example and made in reference to the annexed drawings wherein:

FIG. 1 is a schematic view of the architecture of a set of electric synapses according to the invention;

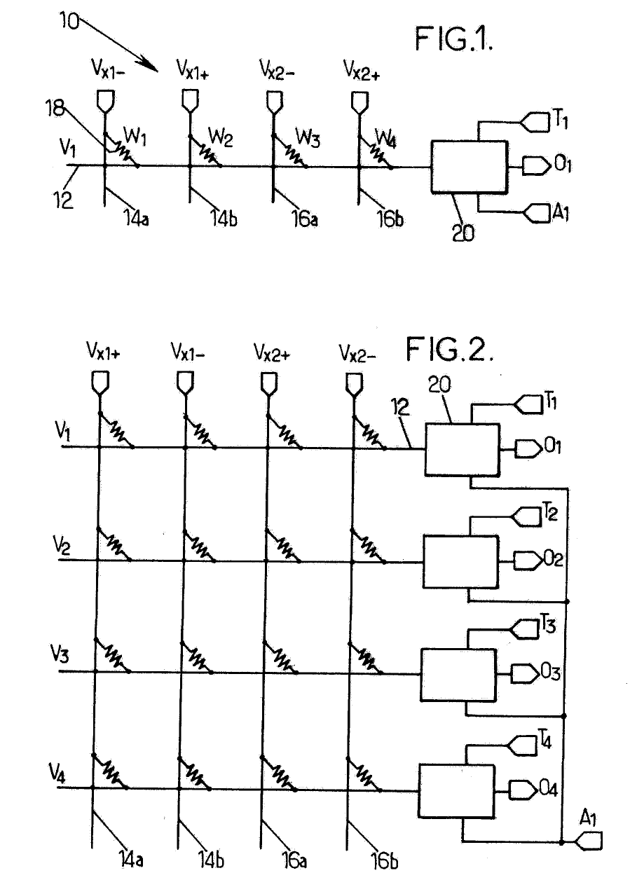

FIG. 2 is a schematic view of a network of electric neurons according to an embodiment;

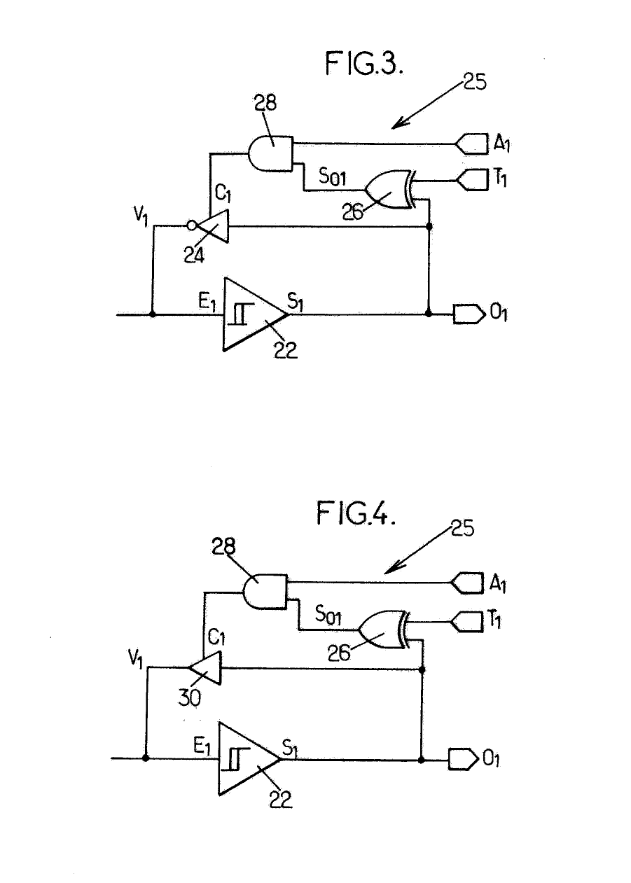

FIG. 3 is a functional view of an electric neuron according to a first embodiment;

FIG. 4 is a functional view of an electric neuron according to a second embodiment.

FIG. 1 shows a schematic view of a set of synapses according to the invention.

In this first embodiment, the set of electric synapses 10 comprises:

a. one main conductor 12 with a potential V1,

b. two pairs of secondary conductors 14a, 14b; 16a, 16b, the first secondary conductors 14a, 16a, of each pair being at the potentials Vₓ₁₋ and Vₓ₂₋ that can vary between −Vn and +Vn and the second secondary conductors 14b, 16b, of each pair are at potentials Vₓ₁₊ and Vₓ₂₊ that can vary between −Vn and +Vn,

c. four nanoconductors 18 each with an adjustable conductance W₁, W₂, W₃, W₄, remaining constant as long as the voltage on the terminals of said nanoconductor remains less in absolute value than a threshold voltage Vt,

the main conductor 12 is connected independently to each secondary conductor 14a, 14b, 16a, 16b, by means of a nanoconductor with an adjustable conductance, one end of the main conductor is connected to an electric neuron 20, said electric neuron being capable of realizing a threshold function and applying a training control potential −Vp or +Vp to the main conductor when voltage O₁ obtained at the output of said threshold function differs from the expected voltage T₁, wherein the potentials Vn and Vp comply with: 2*Vn<Vt and |Vp−Vn|<Vt<|Vp+Vn|.

The variations in the conductances of the four nanoconductors 18 have the same monotony. The nanoconductors can for example be multi-wall carbon nanotubes of which the walls are broken down one by one. The conductance of the multi-wall carbon nanotubes decreases when the voltage on their terminals exceeds a threshold voltage.

FIG. 2 shows the architecture of a network of electric neurons according to an embodiment of the invention.

According to the embodiment shown in FIG. 2, the network of neurons comprises a regular network of four vertical wires and four horizontal wires.

The horizontal wires comprise the main conductors 12 of the various electric synapses of the network, and the vertical wires comprise the secondary conductors 14a, 14b, 16a, 16b of said electric synapses.

At each intersection is located a multi-wall carbon nanotube of which the conductance decreases when the voltage on these terminals exceeds in absolute value a threshold voltage Vt. The conductance of each nanotube remains constant as long as the voltage on its terminals remains less in absolute value than the threshold voltage Vt.

The secondary conductors 14a, 14b, 16a, 16b are the binary inputs X1−, X1+, X2−, X2+ of the network. Each secondary conductor being at an input potential V_{X1-}, V_{X1+}, V_{X2-}, V_{X2+}.

In the operating phase, the potential of the main conductor of each dendrite V1, V2, V3, V4 corresponds to a linear combination of input potentials V_{X1-}, V_{X1+}, V_{X2-}, V_{X2+}.

The potential of the main conductor on each dendrite V1, V2, V3, V4 is therefore comprised between the potentials associated with the upper +Vn and lower −Vn logic levels.

The difference in potentials at the terminals of each conductance is then less in absolute value than 2×Vn.

The logic level Vn is selected in such a way that a voltage 2×Vn is not sufficient to modify the state of conduction of the nanotubes, for example 2×Vn<Vt.

Electric neurons 20 are connected to each main conductor 12 and they behave as non-linear decision-making components, in particular as a threshold function.

Said threshold function of each neuron 20 determines the voltage O₁, O₂, O₃, O₄ obtained at the output of said neuron according to the linear combination of the inputs weighted by the value of the conductances, i.e. for:
the neuron 1: W₁₁*V_{X1-}+W₂₁*V_{X1+}+W₃₁*V_{X2-}+W₄₁*V_{X2+},
the neuron 2: W₁₂*V_{X1-}+W₂₂*V_{X1+}+W₃₂*V_{X2-}+W₄₂*V_{X2+},
the neuron 3: W₁₃*V_{X1-}+W₂₃*V_{X1+}+W₃₃*V_{X2-}+W₄₃*V_{X2+},
the neuron 4: W₁₄*V_{X1-}+W₂₄*V_{X1+}+W₃₄*V_{X2-}+W₄₄*V_{X2+},

Each neuron is able to impose a training control potential Va equal to +Vp or −Vp to the main conductor 12 to which it is connected when the voltage O₁, O₂, O₃, O₄ obtained is different from the expected voltage T₁, T₂, T₃, T₄.

The training control potential Va equal to +Vp or −Vp is selected in such a way that it is sufficient in order to modify the conductances which must be modified without modifying those that must not be modified.

As such, each conductance of a given synapse will be modified if the training control potential Va and the potential of the secondary conductor to which said conductance is connected are of opposite signs. However, this conductance will not be modified if the training control potential Va and the potential of the secondary conductor to which said conductance is connected are of the same sign. More preferably the training control potential Va equal to +Vp or −Vp complies with:

|Vp−Vn|<Vt<|Vp+Vn|.

In a preferred embodiment of the invention, the training control potential Va is selected as being equal to the threshold voltage Vt.

The neurons 20 must be adapted to the type of conductance of the synapse to which they are connected.

FIG. 3 is a functional view of a neuron 20 allowing for the training of logic functions in the case where the conductances of the nanoconductors of the synapse to which said neuron 20 is connected undergo a decrease when the voltage on their terminals is greater than Vt.

The neuron 20 comprises a threshold device 22 being capable of realizing a threshold function.

The threshold device 22 receives as input an input voltage E₁ that it compares with a predetermined threshold voltage value S₁. The voltage O₁ obtained at the output of the threshold device depends on the comparison of the values of the voltages E₁ and S₁.

The voltage O₁ obtained is then sent on the one hand as input for a three-level inverter 24 and on the other hand as input to a control device 25.

The three-level inverter 24 is controlled by a control voltage C₁.

In this embodiment, when the control voltage C₁ of the three-level inverter 24 is non-zero, the output of the three-level inverter is of the opposite sign of the output voltage O₁. Furthermore, when the control voltage C₁ of the three-level inverter 24 is zero, the three-level inverter behaves as an open switch.

The control voltage C₁ of the three-level inverter 24 is obtained by means of the control device 25.

The control device 25 comprises an “XOR” device 26 as well as an “AND” device 28.

The “XOR” device 26 compares the voltage O₁ obtained and the expected voltage T₁.

If the voltage O₁ obtained is different from the expected voltage T₁, the output voltage S_{O1} of the “XOR” device 26 will be zero.

On the contrary, if the obtained O₁ and expected T₁ voltages are equal, the output voltage S_{O1} will be non-zero.

The output voltage S_{O1} is multiplied with a training voltage A₁ by means of the “AND” device 28.

The training voltage A₁ is non-zero in the training phase and zero in operating phase.

The “AND” device delivers as output the control voltage C₁ received by the controlled inverter 24.

Finally, in the training phase, A₁ non-zero, when there is a difference between the obtained O₁ and expected T₁ voltages, a potential of amplitude Vp is imposed at the input of the neuron in absolute value and of the opposite sign to the voltage O₁ obtained.

As such, half of the conductances associated with the set of synapses connected to the neuron 20 have their conductance decreased: the conductances of which the voltage on their terminals is equal to Vn+Vp or −Vn−Vp. The decrease in these conductances results in a decrease in the erroneous correlation between the inputs V_{X1-}, V_{X1+}, V_{X2-}, V_{X2+} and the voltage O₁ obtained which will tend to move towards the voltage O₁ obtained with the expected voltage T₁.

In the training phase, when the expected T₁ and obtained O₁ voltages agree, no potential is imposed at the input of the neuron 20.

In the operating phase, A₁ is zero, no potential is imposed at the input of the neuron 20.

Advantageously, such a functional architecture of the network of neurons makes it possible to modify the values of the conductances over all of the synapses without having to intervene on each nanoconductor.

FIG. 4 is a functional view of a neuron 20 allowing for the training of logic functions in the case where the conductances of the nanoconductors of the set of synapses to which said neuron 20 is connected undergo an increase when the voltage on their terminals is greater than Vt.

The neuron 20 comprises a threshold device 22 being capable of realizing a threshold function.

The threshold device 22 receives as input an input voltage E₁ that it compares with a predetermined threshold voltage value S₁. The voltage O₁ obtained at the output of the threshold device depends on the comparison of the values E₁ and S₁.

The voltage O₁ obtained is then sent on the one hand as input of a controlled gate 30 and on the other hand as input to a control device 25.

In this embodiment, the controlled gate 30 imposes on its output an potential of the same sign as the output voltage O₁ when its control voltage C₁ is non-zero. Furthermore, when the controlled gate 30 receives a zero control voltage C₁, it behaves as an open switch.

The control voltage C₁ of the controlled door 30 is obtained by means of the control device 25.

The control device 25 is identical to the control device in FIG. 2.

Finally, in the training phase, when there is a difference between the voltage O₁ obtained and the expected voltage T₁, a potential of amplitude Vp is imposed at the input of the neuron 20 in absolute value and of the same sign as the obtained output O₁.

As such, half of the conductances associated with the set of synapses connected to the neuron 20 have their conductances increased: the conductances of which the voltage on their terminals is equal to Vn+Vp or −Vn−Vp. The increase in these conductances results in an increase in the correlation between the V_{X1-}, V_{X1+}, V_{X2-}, V_{X2+} and the voltage O₁ obtained which is going to tend to move the voltage O₁ obtained towards the expected voltage T₁.

In the training phase, when the expected T₁ and obtained O₁ voltages agree, no potential is imposed at the input of the neuron 20.

In the operating phase, no potential is imposed at the input of the neuron 20.

Note that the invention is not limited to the embodiments described hereinabove.

1. The electric synapse comprising at least:
a. a main conductor with a predetermined potential V1,
b. a secondary conductor, said secondary conductor being at a potential V_{X1-}, that can vary between Vref−Vn and Vref+Vn, Vref being the reference potential,
c. a nanoconductor with an adjustable conductance W₁, the conductance W₁ remaining constant as long as the voltage on the terminals of said nanoconductor remains less in absolute value than a threshold voltage Vt,
the main conductor being connected to said secondary conductor by means of a nanoconductor with an adjustable conductance, one end at least of the main conductor being connected to an electric neuron,
wherein said electric neuron is capable of realizing a threshold function and applying a training control potential Va equal to Vref−Vp or Vref+Vp to the main conductor when the voltage O₁ obtained at the output of said threshold function differs from the expected voltage T₁ and, wherein the potentials Vn and Vp comply with: 2*Vn<Vt and |Vp−Vn|<Vt<|Vp+Vn|, which makes it possible to modify the conductance W₁ of said nanoconductor when its potential V_{X1+} is of the opposite sign, in reference to Vref, to V1−Vref and to not modify said conductance W₁ of said nanoconductor when its potential is of the same sign, in reference to Vref, as V1−Vref.

2. The set of electric synapses comprising at least:
a. a synapse according to claim 1,
b. a second secondary conductor, said second secondary conductor being at a potential V_{X1-}, that can vary between Vref−Vn and Vref+Vn, in such a way that the average potential between V_{X1+}, and V_{X1-}, is equal to Vref, Vref being the reference potential,
c. a second nanoconductor with an adjustable conductance W₂, said conductance W₂, remaining constant as long as the voltage on the terminals of said nanoconductor remains less in absolute value than a threshold voltage Vt,
the main conductor being linked independently to each secondary conductor by means of a nanoconductor with an adjustable conductance, one end at least of the main conductor being connected to an electric neuron,
wherein said electric neuron is capable of realizing a threshold function and applying a training control potential Vp to the main conductor when the voltage O₁ obtained at the output of said threshold function differs from the expected voltage T₁, the potentials Vn and Vp complying with: 2*Vn<Vt and |Vp−Vn|<Vt<|Vp+Vn|, which makes it possible to modify the conductance W₁, W₂, of any nanoconductor of which the potential V_{X1-}, V_{X1+}, is of the opposite sign, in reference to Vref, to V1−Vref and to not modify said conductance W₁, W₂, of any nanoconductor of which the potential V_{X1-}, V_{X1+}, is of the same sign, in reference to Vref, as V1−Vref.

3. The set of synapses according to claim 2, wherein the variation in the conductance W₁, W₂, of each nanoconductor according to the voltage on the terminals of each nanoconductor is monotonic.

4. The set of synapses according to claim 3, wherein the variations in the conductances according to the voltage of any nanoconductor subset have the same monotony.

5. The set of synapses according to claim 2 wherein the nanoconductors are multi-wall carbon nanotubes.

6. The set of synapses according to claim 3 wherein when the nanoconductors are of decreasing conductance the electric neuron is conformed in such a way as to apply a training control potential V1 equal to Vref−Vp or Vref+Vp of the opposite sign to the voltage O₁ obtained at the output of said threshold function.

7. The set of synapses according to claim 2 wherein when the nanoconductors are of increasing conductance the electric neuron is conformed in such a way as to apply a training control potential V1 equal to Vref−Vp or Vref+Vp of the same sign as the voltage O₁ obtained at the output of said threshold function.

8. The network of neurons comprising a plurality of synapses according to claim 1, wherein for each synapse of said network each of its secondary conductors is electrically connected to at least one main conductor different from another synapse in the network.

9. The training method of a synapse or of a set of synapses according to claim 1 wherein when the voltage O₁ obtained at the output of the threshold function differs from the expected voltage T₁, the potential Va equal to Vref+Vp or Vref−Vp, complying with |Vp−Vn|<Vt<|Vp+Vn|, is applied to the main conductor.

10. The training method of a network of neurons according to claim 8, wherein the method according to claim 9 is applied globally to each synapse of said network by means of the potential Va equal to Vref+Vp or Vref−Vp.

11. A network of neurons comprising a plurality of sets of synapses according to claim 2, wherein for each synapse of said network each of its secondary conductors is electrically connected to at least one main conductor different from another synapse in the network.

12. A training method of a set of synapses according to claim 2, wherein when the voltage O₁ obtained at the output of the threshold function differs from the expected voltage T₁, the potential Va equal to Vref+Vp or Vref−Vp, complying with |Vp−Vn|<Vt<|Vp+Vn|, is applied to the main conductor.

13. A training method of a network of neurons comprising a plurality of sets of synapses including a main conductor with a predetermined potential V1, a secondary conductor, said secondary conductor being at a potential V_{X1-}, that can vary between Vref−Vn and Vref+Vn, Vref being the reference potential, a nanoconductor with an adjustable conductance W₁, the conductance W₁ remaining constant as long as the voltage on the terminals of said nanoconductor remains less in absolute value than a threshold voltage Vt, the main conductor being connected to said secondary conductor by means of a nanoconductor with an adjustable conductance, one end at least of the main conductor being connected to an electric neuron, wherein said electric neuron is capable of realizing a threshold function and applying a training control potential Va equal to Vref−Vp or Vref+Vp to the main conductor when the voltage O₁ obtained at the output of said threshold function differs from the expected voltage T₁ and, wherein the potentials Vn and Vp comply with: 2*Vn<Vt and |Vp−Vn|<Vt<|Vp+Vn|, which makes it possible to modify the conductance W₁ of said nanoconductor when its potential V_{X1+} is of the opposite sign, in reference to Vref, to V1−Vref and to not modify said conductance W₁ of said nanoconductor when its potential is of the same sign, in reference to Vref, as V1−Vref,
wherein the set of electric synapses further including a second secondary conductor, said second secondary being at a potential V_{X1-}, that can vary between Vref−Vn and Vref+Vn, in such a way that the average potential between V_{X1+}, and V_{X1-}, is equal to Vref, Vref being the reference potential, a second nanoconductor with an adjustable conductance W₂, said conductance W₂, remaining constant as long as the voltage on the terminals of said nanoconductor remains less in absolute value than a threshold voltage Vt, the main conductor being linked independently to each secondary conductor by means of a nanoconductor with an adjustable conductance, one end at least of the main conductor being connected to an electric neuron, wherein said electric neuron is capable of realizing a threshold function and applying a training control potential Vp to the main conductor when the voltage O₁ obtained at the output of said threshold function differs from the expected voltage T₁, the potentials Vn and Vp complying with: 2*Vn<Vt and |Vp−Vn|<Vt<|Vp+Vn|, which makes it possible to modify the conductance W₁, W₂, of any nanoconductor of which the potential V_{X1-}, V_{X1+}, is of the opposite sign, in reference to Vref, to V1−Vref and to not modify said conductance W₁, W₂, of any nanoconductor of which the potential V_{X1-}, V_{X1+}, is of the same sign, in reference to Vref, as V1−Vref,
wherein for each synapse of said network each of its secondary conductors is electrically connected to at least one main conductor different from another synapse in the network, and
wherein the method according to claim 10 is applied globally to each set of synapses of said network by means of the potential Va equal to Vref+Vp or Vref−Vp.
